(19) United States
(12) Patent Application Publication
(10) Pub. No.: US 2003/0120425 A1
(43) Pub. Date: Jun. 26, 2003

(54) Self-correcting wireless inertial navigation system and method

(76) Inventors: Kevin Stanley, Burnaby (CA); Q.M. Jonathan Wu, Vancouver (CA); Tom Vanderhoek, Vancouver (CA)

Correspondence Address: LONG AND CAMERON, SUITE 1401 - 1166 ALBERNI STREET, VANCOUVER, BC, V6E 3Z3, CA

(21) Appl. No.: 10/025,499

(22) Filed: Dec. 26, 2001

(51) Int. Cl. G01C 21/20

(52) U.S. Cl. 701/220; 701/207

(57) ABSTRACT

A self-correcting wireless inertial navigation system and method employ a mobile unit having an inertial sensor and a transmitter connected to the output of the initial sensor for broadcasting an RF measurement signal. A base station has receivers responsive to the signal, an interferometer connected to the receivers and a processor programmed to obtain inertial measurements from the signal and to correct the measurements in accordance with phase difference triangulation information derived by the interferometer.

### BACKGROUND OF THE INVENTION

1. Field of the Invention

The present invention relates to a self-correcting wireless inertial navigation system and to a method of self-correcting wireless inertial navigation and is useful in particular, but not exclusively, for local position measurement, which is useful for many different applications, for example computer input, docking, robotic programming, and other measurement tasks.

2. Description of the Related Art

The Global Positioning System (GPS) has revolutionized position sensing for large-scale outdoor systems, such as shipping and land navigation. However, GPS technology cannot be directly applied to small scale position measurement because clocks cannot count fast enough to time short duration light pulses.

Ultrasonic systems imitating the Global Positioning System have been investigated, but suffer from inaccuracies caused by moving air currents, echoes and acoustic noise. One prior art local position sensing system employs magnetic sensors and emitters to detect position for motion capture, and is usually used in film gaming and virtual reality applications.

Other researchers have attempted to directly use phase information to track position. For example, one prior art system uses a coarse and a fine frequency measurement to determine the location of a transmitter as a function of wavelength. However, phase measurement alone cannot determine the world coordinates of a target. If the transmitter moves more than a single wavelength during a measurement iteration, the absolute position of the transmitter becomes uncertain.

Inertial navigation systems have been investigated for local position measurement. However, inertial systems suffer from integrator drift and must be compensated or calibrated using a secondary measurement system.

In U.S. Pat. No. 6,176,837, issued Jan. 23rd, 2001 to Eric M. Foxlin, there is disclosed a tracking system and method for tracking the position of a body which employ two sensor systems to obtain two types of measurements associated with motion of the body, one comprising acoustic measurement. An estimate of the orientation and position of the body is updated, based on, for example, inertial measurement, and the estimate is then updated based on, for example, acoustic ranging.

It has also been proposed to effect motion tracking by a combination of inertial, ultrasonic and geomagnetic sensors for use, in particular, in high-end virtual reality and military applications.

### BRIEF SUMMARY OF THE INVENTION

According to the present invention, the position of a mobile unit is determined by inertial sensing of the position, by phase difference triangulation measurement of the position and by employing the phase difference triangulation measurement to correct the inertial sensing of the position.

Preferably, measurement of the position of a mobile unit by the inertial sensing is transmitted as an RF signal from the mobile unit to a base unit, and the RF signal is also employed for the phase difference triangulation measurement, which enables the present invention to be implemented in an elegant and inexpensive manner.

Thus, phase information from the RF signal may be employed to correct the inertial position measurement for drift. The inertial sensing provides global position information, independent of a line of sight. The phase information from the phase difference triangulation measurement ensures that local error does not accumulate.

When the communication system employed for transmitting and receiving the RF signal is also employed for the phase difference triangulation, the present system can be implemented in an elegant and inexpensive manner.

### BRIEF DESCRIPTION OF THE DRAWINGS

The present invention will be more readily apparent from the following description of a preferred embodiment thereof given, by way of example, with reference to the accompanying drawings, in which:

FIG. 1 shows a block diagram of a self-correcting wireless inertial navigation system embodying the present invention; and

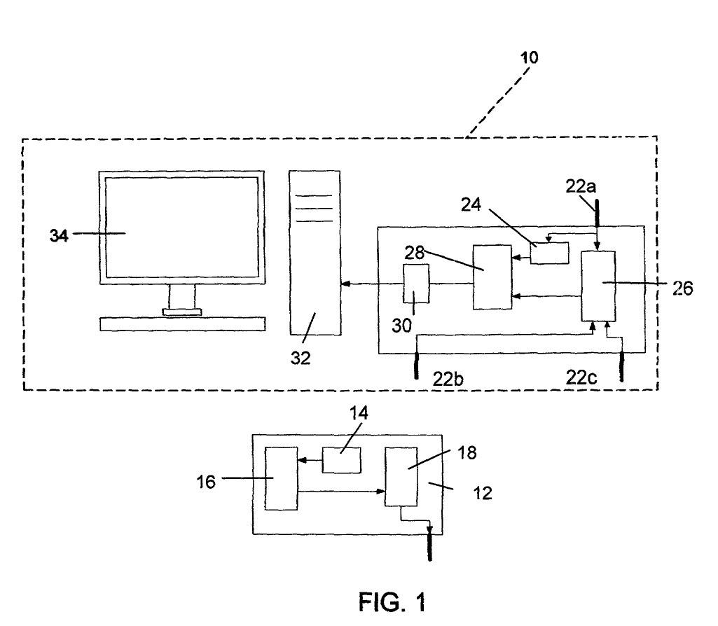

FIG. 2 shows a block diagram of parts of the system of FIG. 1.

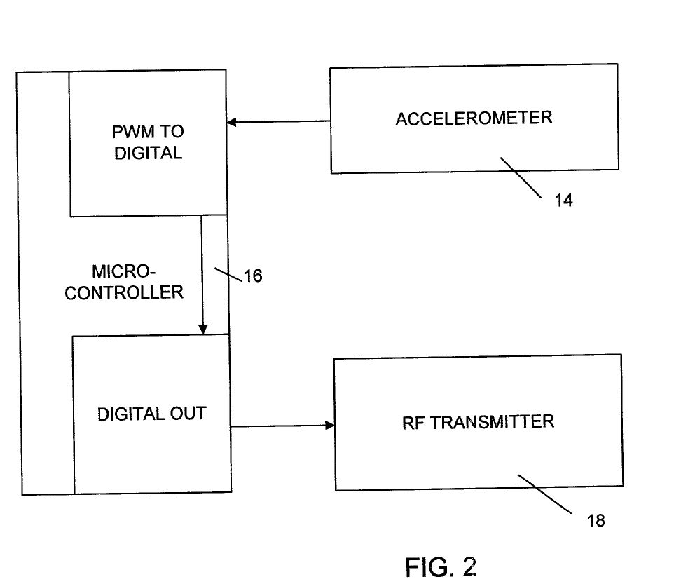

### DESCRIPTION OF THE PREFERRED EMBODIMENT

In the accompanying drawings, there is shown a self-correcting wireless inertial navigation system which includes a base station 10 and a mobile unit 12. The mobile unit 12 in includes an accelerometer 14, which in the present embodiment of the invention is in implemented as an ADXL202 two-axis accelerometer manufactured by Analog Devices Inc., a microcontroller 16, implemented as a PIC16 F876-20 microcontroller manufactured by Microchip Corp., and a transmitter 18 in the form of a TXM-900-HP II receiver board having an antenna 20 for broadcasting a measurement signal in the form of an RF signal.

The base station 10 has three antennas 22a, 22b and 22c for receiving the measurement signal. This antenna 22a is connected to an RF receiver 24, implemented as an RXM-900-HP-II receiver board on an MDEV-900-HP-II evaluation board manufactured by Linx Technologies Inc. The two antennas 22b and 22c are connected to an interferometer/phase detector 26 in the form of an AD8302 RF/IF Gain and Phase Detector manufactured by Analog Devices Inc. and the antenna 22a is also connected to the interferometer/phase detector 26. The receiver 24 and the interferometer/phase detector 26 are connected to a PIC16F876-20 microcontroller 28, which outputs through a MAX233 serial driver 30, manufactured by Maxim Integrated Products, to a Dell Optiflex GXPro Dual 200 MHz Pentium Pro personal computer 32. A monitor 34 is provided for displaying the output of the personal computer 32.

In the operation of this system, the accelerometer 14, acting as an inertial sensor, provides a pulse width modulated inertial sensor output signal for each axis to the microcontroller 16, which supplies a corresponding frequency shift keyed signal to the transmitter 18 for broadcasting the inertial measurement data as the RF measurement signal from the antenna 20 of the mobile unit 12 to the antennas 22a-c of the base station 10.

At the base station 10, the interferometer/phase detector 26 effects phase difference triangulation of the RF measurement signal from the antennas 22b and 22c and provides a corresponding output to the microcontroller 28. The inertial measurement data, through the antenna 22a and the receiver 24, is supplied directly to the microcontroller 28.

The personal computer 32 is configured to employ the phase difference triangulation output from the interferometer/phase detector 26 to correct the inertial measurement and to output corresponding data to the monitor 34.

The inertial measurement data is derived as follows:

Acceleration measurements made by the accelerometer 14 are integrated twice to arrive at displacement. That is

Δx=∫∫xdt (1)

To obtain distance traveled during a single sampling interval of the accelerometer system

Δx=xᵢT (2)

where

Δx=xᵢT+xᵢ₋₁ (3)

and T is the sampling interval. That is, the distance traveled during time period T is the average velocity during T, time T.

The position from a known starting point x₀ is therefore

$${x}_{i} = {\sum }_{j} Δ {x}_{l} = {x}_{0} \qquad ( 4 )$$

However, errors are also summed. Maximum error grows linearly with i as:

eᵢ=ieₘₐₓ (5)

the error at iteration i is equal to the number of iterations multiplied by the maximum inertial measurement error. The maximum error is an amalgamation of sensor error, signal conditioning error and digitizer resolution. Generally, the sensor error dominates, and the other two error sources can be ignored.

Because very accurate measurements over extended time periods are required, sensor drift due to error accumulation is a primary concern. The sensor error is fixed by the component manufacturers, so error can only be controlled by altering i, the number of iterations between land marking operations. Because a reasonably high refresh rate, and continuation of operations for an extended period of time are required, i cannot implicitly be changed. However, by employing a secondary measurement system, we can maintain i=1. The maximum error from the accelerometer will then be

e=max(eᵢₙₑᵣₜᵢₐₗ′e_{local}) (6)

The error will be the greater of the inertial measurement error or the local measurement error. Because the inertial system is rezeroed at every iteration, i is fixed at 1.

The correction of the inertial measurement by phase difference triangulation measurement is effected in accordance with the following equations, which show the manner of calculating the position of the mobile unit 12 based on the two receiving antennas 22b and 22c, both at a distance r from the origin. In the following calculation, λ is the carrier wavelength, φ is the measured phase angle, and d₁ and d₂ are the respective distances from the transmitter to each receiving antenna.

d₁=kλ+m

d₂=jλ+n

$${d}_{1} - {d}_{2} = ( k - j ) λ + ( m - n ) \pm ( \frac{m - n}{λ} ) = \frac{φ}{π} \pm \frac{q}{2}$$

The first plus/minus is required because we do not measure which wave is leading. The second plus/minus is required to correct the phase to correspond from 0 to 360 degrees, even though phase only measures from 0 to 90 degrees.

From the estimated position of the transmitter, based on the inertial measurement:

\tilde{d}₁={square root over ((\tilde{x})}+r)²+\tilde{y}²

\tilde{d}₂={square root over ((\tilde{x})}−r)²+\tilde{y}²

$$\tilde{k} = floor ( \frac{{\tilde{d}}_{1}}{λ} )$$

$$\tilde{j} = floor ( \frac{{\tilde{d}}_{2}}{λ} )$$

\tilde{m}=\tilde{d}₁−\tilde{k}λ

ñ=\tilde{d}₂−\tilde{j}λ

The minimum distance to (m, n) on the line

$$m = n \pm \frac{φ λ}{π} \pm \frac{q}{2}$$

along the perpendicular line

m=(\tilde{m}+ñ)−n

is given by:

$$n = \frac{( \tilde{m} + \tilde{n} )}{2} \pm \frac{φ λ}{2 π} \pm \frac{q}{4}$$

Back substitution yields m.

By substituting the measured m and n in for the estimated m, and n, the new distances are calculated.

d₁=kλ+m

d₂=jλ+n

The actual position is determined using triangulation.

$${( x + r )}^{2} + {y}^{2} = {{d}_{1}^{2} \\ ( x - r )}^{2} + {y}^{2} = {d}_{2}^{2}$$

Which can be solved as:

$$x = \frac{{d}_{1}^{2} - {d}_{2}^{2}}{4 r}$$

$$y = \pm \sqrt{{d}_{2}^{2} - {( \frac{{d}_{1}^{2} - {d}_{2}^{2}}{4 r} )}^{2}}$$

The new measured position is given by (x, y), where y is chosen as the solution which lies in the positive half plane

We claim:

1. A self-correcting inertial navigation system, comprising:
inertial sensor means for providing an inertial measurement signal containing inertial position data representing the position of said mobile unit and means responsive to said measurement signal for broadcasting an RF signal containing said inertial position measurement data;
first means for deriving said inertial position data from said RF signal;
second means for effecting phase difference triangulation measurement of said RF signal to provide phase information;
data processing means responsive to said inertial position data from said first means and said phase information from said phase difference triangulation measurement means for employing said phase information to provide an output representing said inertial position data corrected for drift; and
display means for displaying said output of said data processing means.

2. A self-correcting inertial navigation system, comprising;
a mobile unit;
said mobile unit comprising an inertial position sensor and an RF transmitter; and
a base station;
said base station having a receiver responsive to inertial position data from said inertial position sensor broadcast by said RF transmitter; and
phase difference triangulation apparatus responsive to signals from said mobile unit;
a data processor connected to said receiver and said phase difference triangulation apparatus for correcting the inertial position data for drift; and
a corrected measurement display connected to said data processor.

3. A self-correcting inertial navigation system as claimed in claim 2, wherein said receiver and said phase difference triangulation apparatus are both responsive to a common RF signal from said RF transmitter.

4. A self-correcting inertial navigation system, comprising:
a mobile unit;
said mobile unit having an accelerometer, an RF transmitter and a microcontroller connected between said accelerometer and said RF transmitter; and
a base station;
said base station having a receiver responsive to signals from said RF transmitter, a phase difference triangulation apparatus responsive to signals from said RF transmitter, a data processor responsive to outputs from said receiver and from said phase difference triangulation apparatus to provide an output representing measurement of the position of said mobile unit corrected for drift; and
an output device for indicating said corrected measurement.

5. A position measurement system, comprising:
a mobile unit;
said mobile unit comprising an inertial sensor and a transmitter connected to an output of said inertial sensor for broadcasting a corresponding measurement signal; and
a base station responsive to the measurement signal, said base station including receivers, an interferometer and a processor programmed to obtain inertial position information from the measurement signal and phase difference information from said interferometer and to provide a position measurement based on said inertial position information and corrected by said phase difference information.

6. A position measurement system, comprising:
a mobile unit;
said mobile unit comprising an inertial sensor and a transmitter connected to an output of said inertial sensor;
a base station;
said base station comprising a receiver, a first antenna connected to said receiver, second and third antennas spaced apart from one another, a phase detector responsive to phase differences in said signal at said second and third antennas to provide phase difference information and a processor configured to provide a measurement of the position of said mobile unit based on inertial information received by said receiver from said inertial sensor and to correct said position measurement in accordance with said phase difference information.

7. A method of measuring the position of a mobile unit, which comprises the steps of employing inertial sensing of the position of said mobile unit to provide an inertial sensing data signal, broadcasting said signal, detecting said signal at separate locations, detecting phase differences between said signal at said separate locations, deriving inertial position information from said signal, and outputting a position measurement based on said inertial sensing and corrected by said phase differences.

8. A method of determining the position of a mobile unit, which includes effecting inertial sensing measurement of the position and phase difference triangulation measurement of the position and employing the phase difference triangulation measurement to correct the inertial sensing measurement.
